(19) United States
(12) Patent Application Publication
(10) Pub. No.: US 2011/0285703 A1
(43) Pub. Date: Nov. 24, 2011

(54) 3D AVATAR SERVICE PROVIDING SYSTEM AND METHOD USING BACKGROUND IMAGE

(75) Inventor: Sehyung Jin, Seoul (KR)

(73) Assignee: TRI-D COMMUNICATIONS, Seoul (KR)

(21) Appl. No.: 13/147,122

(22) PCT Filed: Aug. 30, 2010
(86) PCT No.: PCT/KR10/05824

§ 371 Date: Jul. 29, 2011

(30) Foreign Application Priority Data
Sep. 10, 2009 (KR) 10-2009-0085283

(51) Int. Cl. G06T 15/00

(52) U.S. Cl. 345/419

(57) ABSTRACT

Disclosed are a system and a method for providing an avatar service with the background having the reality. A 3-D avatar service is provided under a 2-D background image and a user feels as if the 2-D background image is realized as a 3-D space. Thus, the user feels the reality as if the avatar exists in the 3-D space based on the 2-D images photographed by a camera without performing the 3-D rendering.

### TECHNICAL FIELD

The present invention relates to a system and a method for providing a 3-D image including a 3-D avatar on a screen.

### BACKGROUND ART

Recently, with the development of the three-dimensional (3-D) graphic technology and computer hardware, the 3-D images are extensively used in various fields. In particular, the 3-D graphic technology is used in the field of games and on-line communities to provide the image having the reality.

In order to provide the 3-D image, a modeled 3-D object is positioned in a 3-D virtual space and an image, which is obtained when viewing the 3-D virtual space at a specific time point, is provided by rendering the image into a 2-D image. In this manner, the user may feel as if the user views the 3-D image through a display device that displays the 2-D image.

According to the above method, the 3-D object positioned in the 3-D virtual space must be modeled to provide the 3-D image. However, it takes long time and high cost to model the 3-D object approximately to the reality.

Recently, various services are provided through on-line to allow users to communicate with other users on the concept of the virtual reality, so there are demands to communicate with other users in the space having the reality. In this regard, many users demand for the 3-D images provided with the concrete background, other than the simple 3-D images. In particular, many users want to use the image by forming the space of the streets and the buildings with the 3-D image approximate to the reality.

According to the related art, the 3-D images are provided by modeling real buildings or various articles, so it takes long time and high cost to model the 3-D object approximately to the reality. In addition, simple objects are obtained even if the modeling work is performed, so these objects may lack of the reality.

Therefore, it is necessary to provide a system and a method capable of providing the 3-D space with the background having the reality without performing the modeling work for all background.

### DISCLOSURE

[Technical Problem]

The present invention may provide a system and a method capable of providing a 3-D image having the reality.

The present invention may provide a system and a method capable of providing a 3-D avatar service with the background having the reality.

The present invention may provide a system and a method capable of providing a 3-D avatar service, in which an avatar can move under the background having the reality without modeling the background, such as real buildings.

The present invention may provide a system and a method capable of providing a 3-D image without performing the 3-D modeling work by mapping a 2-D image with a 3-D object and setting an internal view point in the 3-D object.

[Technical Solution]

According to one embodiment of the present invention, there is provided a system for providing a 3-D avatar service. The system may include an image data storage unit for storing 2-D image data photographed from at least one camera position, and coordinate information of each camera position on an X-Y plane in correspondence with the camera position, an avatar position storage unit for storing coordinate information of at least one 3-D avatar on the X-Y plane, a 3-D image providing module positioning a 3-D object such that the 3-D object has a center on a coordinate of the camera position, mapping the 2-D image data corresponding to the camera position in the 3-D object, positioning the 3-D avatar on the X-Y plane based on the coordinate information of the 3-D avatar, and providing a 3-D image having a view point on the center of the 3-D object, a command receiving unit for receiving an avatar moving command or a screen rotating command from a user, and a controller for moving an avatar of the user on the X-Y plane according to the avatar moving command and rotating an angle of a screen, which is provided at the viewpoint, according to the screen rotating command.

The controller may check whether the avatar of the user deviates from a first region having a center on the coordinate of the camera position on the X-Y plane, and control the 3-D image providing module to provide the 3-D image using the 2-D image data corresponding to the camera position closest to the avatar of the user, if the avatar of the user deviates from the first region.

The 3-D image providing module may display avatars positioned in a second region having a center on the coordinate of the camera position on the X-Y plane.

The center of the 3-D object may be located at a position, which is spaced in a Z-axis direction by a height of the camera position on the X-Y plane.

The 3-D image providing module may display the 3-D avatars after displaying the 3-D object mapped with the 2-D image data.

The 3-D image providing module may adjust a size of the 3-D avatars according to a distance between the coordinate of the camera position and the coordinate of the 3-D avatars.

The 3-D object may have a spherical shape.

According to another aspect of the present invention, there is provided a method for providing a 3-D avatar service. The method may include the steps of storing 2-D image data photographed from at least one camera position, and coordinate information of each camera position on an X-Y plane in correspondence with the camera position, storing coordinate information of at least one 3-D avatar on the X-Y plane, positioning a 3-D object such that the 3-D object has a center on a coordinate of the camera position, mapping the 2-D image data corresponding to the camera position in the 3-D object, positioning the 3-D avatar on the X-Y plane based on the coordinate information of the 3-D avatar, providing a 3-D image having a view point on the center of the 3-D object, receiving an avatar moving command or a screen rotating command from a user, and moving an avatar of the user on the X-Y plane according to the avatar moving command and rotating an angle of a screen, which is provided at the view point, according to the screen rotating command.

The method may further include checking whether the avatar of the user deviates from a first region having a center on the coordinate of the camera position on the X-Y plane, and providing the 3-D image using the 2-D image data corresponding to the camera position closest to the avatar of the user if the avatar of the user deviates from the first region.

The providing of the 3-D image may include displaying avatars positioned in a second region having a center on the coordinate of the camera position on the X-Y plane.

The center of the 3-D object may be located at a position, which is spaced in a Z-axis direction by a height of the camera position on the X-Y plane.

The positioning of the 3-D avatar may include adjusting a size of the 3-D avatars according to a distance between the coordinate of the camera position and the coordinate of the 3-D avatars.

The 3-D object may have a spherical shape.

According to still another aspect of the present invention, there is provided a computer readable recording medium recorded with a program for executing the method for providing the 3-D avatar service.

[Advantageous Effects]

The present invention can provide a system and a method capable of providing a 3-D image having the reality.

The present invention can provide a system and a method capable of providing a 3-D avatar service with the background having the reality.

The present invention can provide a system and a method capable of providing a 3-D avatar service, in which an avatar can move under the background having the reality without modeling the background, such as real buildings.

The present invention can provide a system and a method capable of providing a 3-D image without performing the 3-D modeling work by mapping a 2-D image with a 3-D object and setting an internal view point in the 3-D object.

### DESCRIPTION OF DRAWINGS

FIG. 1 is a view schematically showing a system for providing a 3-D avatar service according to one embodiment of the present invention;

FIG. 2 is a view showing the internal structure of a system for providing a 3-D avatar service according to one embodiment of the present invention;

FIG. 3 is a view showing an example of a camera region formed on an X-Y plane in a system for providing a 3-D avatar service according to one embodiment of the present invention;

FIG. 4 is a view showing an example of an avatar display region formed on an X-Y plane in a system for providing a 3-D avatar service according to one embodiment of the present invention;

FIG. 5 is a view showing an example of positioning a 3-D object on an X-Y plane in a system for providing a 3-D avatar service according to one embodiment of the present invention;

FIG. 6 is a view showing an example of a 3-D image provided in a system for providing a 3-D avatar service according to one embodiment of the present invention;

FIG. 7 is a view showing an example of a 3-D image provided in a system for providing a 3-D avatar service according to one embodiment of the present invention when an avatar is moved in a 3-D image;

FIG. 8 is a view showing another example of a 3-D image provided in a system for providing a 3-D avatar service according to one embodiment of the present invention;

FIG. 9 is a view showing another example of a 3-D image provided in a system for providing a 3-D avatar service according to one embodiment of the present invention when an avatar is moved in a 3-D image; and

FIG. 10 is a flowchart showing a method for providing a 3-D avatar service according to one embodiment of the present invention.

### BEST MODE

### Mode for Invention

Hereinafter, exemplary embodiments of the present invention will be described with reference to accompanying drawings. The present invention is not limited to the following embodiments and the same reference numerals will be used to refer to the same elements.

In the dictionary meaning, an avatar refers to a character that represents a person or a user in the virtual reality environment or cyberspace. According to the present invention, the avatar refers to a character, which is handled by the user through commands in the 3-D virtual space. In general, the avatar refers to a character used in the on-line community to represent the user or a character handled by the user in the on-line game. The avatar described in the present invention may refer to the character handled by the user in the 3-D virtual space.

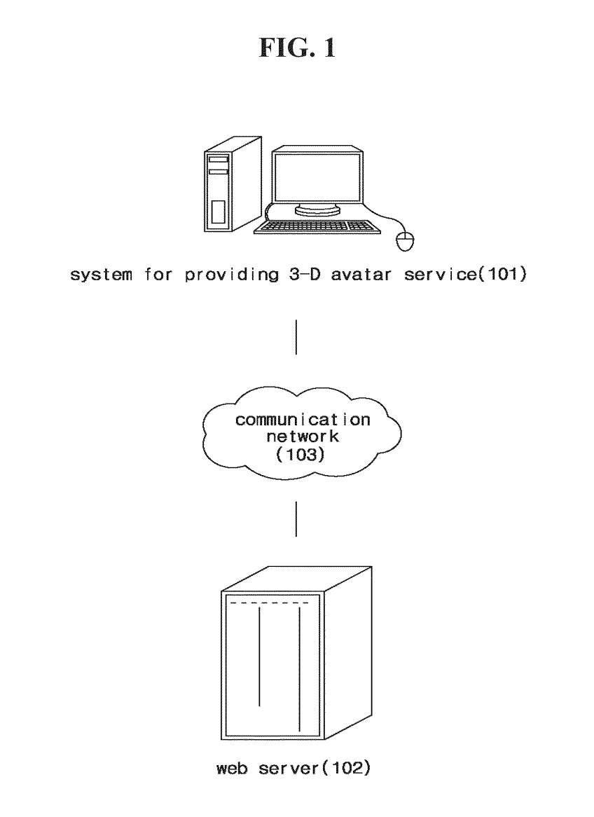

FIG. 1 is a view schematically showing a system for providing a 3-D avatar service according to one embodiment of the present invention.

As shown in FIG. 1, the system 101 for providing the 3-D avatar service (hereinafter, simply referred to as a system) according to one embodiment of the present invention is applicable for a terminal connected to a server 102 through a communication network.

The terminal employing the system 101 may be a personal computer or a portable terminal, such as PDA or PMP. The system 101 may include a CPU (central processing unit) and a memory and can be used for various terminals having the operation processing function. In order to provide a 3-D image, the terminal equipped with the system 101 may have a 3-D acceleration function.

The server 102 stores information related to avatars of members including the user and the background image and provides the information to a terminal apparatus of each member. The information related to the avatars of the members may include a shape of the avatar, items and a position of the avatar in the virtual space. In addition, the information related to the background image may include information about 2-D image data representing the background at a predetermined position. The information related to the avatars and the background image is stored in the server 102 and transmitted to the terminal as the terminal requests the information. In addition, each terminal apparatus stores the information related to the avatars and the background image in a storage unit, such as a hard disc or a memory, installed in the terminal apparatus to provide the user with the 3-D avatar service by using the information.

The communication network 103 transmits the data between the terminal equipped with the system 101 and the server 102. In general, the communication network 103 includes an internet communication network. The communication network 103 can be prepared as a wired communication network or a wireless communication network according to the type of the terminal. Various communication networks can be used if they can transmit/receive information related to the avatar and the background image.

In addition, different from FIG. 1, the system 101 can be installed in the terminal and the server. In this case, the server can be divided into a plurality of servers. In addition, the terminal maybe independently driven without receiving the information from the communication network 103 or the server 102, but the present invention is not limited thereto.

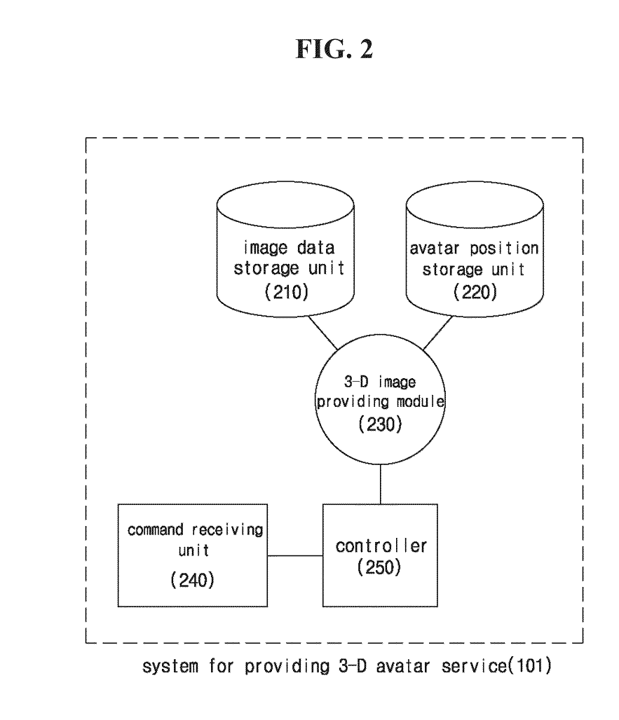

FIG. 2 is a view showing the internal structure of the system 101 for providing the 3-D avatar service according to one embodiment of the present invention.

As shown in FIG. 2, the system 101 includes an image data storage unit 210, an avatar position storage unit 220, a 3-D image providing module 230, a command receiving unit 240 and a controller 250. The above elements can be prepared as software, hardware or the combination of the software and the hardware. In addition, the above elements can be physically or logically connected to each other to receive/transmit the data. Further, the above elements constituting the system 101 can be installed in one terminal or can be distributed in the terminal and the server in such a manner that they can be communicated with each other through the communication network. Hereinafter, the above elements will be described in detail.

The image data storage unit 210 stores the 2-D image data photographed from at least one camera position, and coordinate information of each camera position on an X-Y plane in correspondence with the camera position. The system 101 for providing the 3-D avatar service according to the present invention forms the background of the 3-D space by using the 2-D image photographed through 360° from at least one camera position, thereby providing the user with the 3-D image having the reality without separately modeling the background.

Thus, the image data storage unit 210 processes the 2-D image data, which are photographed from at least one camera position through all directions about the camera position, such that the 2-D image data can be easily mapped with the 3-D image, and stores the 2-D image data. Since the background photographed from a plurality of camera positions must be provided to the user, the image data storage unit 210 may store information representing each camera position in correspondence with the 2-D image photographed from the above camera position. Thus, when the user wants to view the image photographed from a specific camera position, the 2-D image data corresponding to the image can be used.

The information about the camera position stored in the image data storage unit 210 represents the place where the camera photographs the image. When the map is formed with the plane coordinate to represent the position in the real road, the information may be a coordinate representing the position of the camera photographing the image. When the real map is represented as a plane, the X-Y plane described in the present invention refers to the plane indicated in the map when the coordinate is applied to the map. In detail, the X-Y plane may represent the plane corresponding to the ground in the real world. Therefore, if the position of the avatar is set after the camera position is set based on the X-Y plane, the effect is expected as if the camera is provided on the ground and the avatar exists in the real world. The X-Y plane may not exclusively refer to the plane defined by the X-axis and the Y-axis in the real 3-D space. In order to facilitate the explanation, the plane corresponding to the ground in the real world is represented as the X-Y plane, and the axis corresponding to the height in the real world is represented as the Z-axis. This configuration of the X-Y plane can be variously modified.

The image data storage unit 210 may use various storage devices, such as a hard disc, an optical disc or a volatile/nonvolatile memory, to store the 2-D image data in correspondence with the camera position. In addition, the image data storage unit 210 may store information representing the relation between the 2-D image data and the camera position by using various databases, such as Oracle, Ms-SQL or My-SQL. Since it is difficult to store the 2-D image data in the database, the storage device stores information representing an address where the 2-D image data are stored in the database such that the information may correspond to the camera position. This is only one embodiment of the present invention and can be variously modified to the extent that the camera position and the 2-D image data can be stored in correspondence with each other.

In addition, the image data storage unit 210 can store the 2-D image data corresponding to all camera positions provided from the system 101 according to the present invention or can store at least one of the 2-D image data corresponding to plural camera positions. Thus, the 2-D image data corresponding to all camera positions are stored in the server 102 and the system 101 requests the 2-D image data corresponding to the required camera position through the communication network 103. In addition, the system 101 temporally stores the 2-D image data in the storage device, such as the memory or the hard disc, and forms the 3-D image based on the 2-D image data. If the 2-D image data corresponding to all camera positions are stored, there is a problem to store all mass-storage data, but the image obtained from various positions can be provided without accessing the server 102 through the communication network 103. As described above, according to the present invention, the data are distributively stored in the server such that the data can be used upon necessity or all data can be stored in the terminal, but the present invention is not limited thereto.

The avatar position storage unit 220 stores coordinate information of at least one 3-D avatar on the X-Y plane. As mentioned above, the X-Y plane refers to the plane corresponding to the ground in the real world. If the position of the 3-D avatar is represented as the coordinate information on the X-Y plane, the effect is expected as if the avatar exists in the real world. The coordinate information on the X-Y plane can be expressed as (x and y) by storing the coordinate value in the X-axis and the coordinate value in the Y-axis in correspondence with each other. The terms “X and Y” in the coordinate are adopted for the purpose of convenience of explanation and they can be variously modified.

The avatar position storage unit 220 may store the position information of the avatar by using various storage devices, such as a hard disc, an optical disc or a volatile/nonvolatile memory. Similar to the image data storage unit 210, the avatar position storage unit 220 may store the position information of each avatar or at least one avatar on the X-Y plane by using various databases, such as Oracle, Ms-SQL or My-SQL.

The avatar position storage unit 220 may store the position information of the avatars of all members for the system 101 according to the present invention or may store the position information of the avatars of some members. Similar to the image data storage unit 210, the avatar position storage unit 220 may temporally store the information about the position of the avatars, which are provided within the predetermined range having the center on the present camera position, in the memory or the hard disc. If the position of each avatar or the camera position is changed, the avatar position storage unit 220 may update the position information of the avatars by receiving the position information of the avatars from the server 102 storing the position information of all avatars. To this end, the server 102 stores information about the position change of the avatars by receiving the information from the terminals connected to the server 102.

The 3-D image providing module 230 positions a 3-D object such that the 3-D object has the center on the coordinate of the camera position and maps the 2-D image data corresponding to the camera position in the 3-D object. According to the present invention, the image must be provided by using the 2-D image data as if the avatar exists under the 3-D background, the 3-D image providing module 230 positions the 3-D object, maps the 2-D image data in the 3-D object, and positions the view point in the 3-D object. Thus, the user can view the inside of the 3-D object around the view point regardless of the line of vision, so the image having the background of the 2-D image mapped in the 3-D object can be provided.

The 3-D object set by the 3-D image providing module 230 has a spherical shape, so the 2-D image serving as the background can be positioned at the same distance with respect to all angles when viewed from the center of the 3-D object. In addition, the 3-D object may have the regular hexahedral shape in order to facilitate the photographing and mapping work.

The center of the 3-D object is positioned on the coordinate of the camera position on the X-Y plane. Although the center of the 3-D object can be positioned on the X-Y plane, preferably, the center of the 3-D object is located at the position, which is spaced in the Z-axis direction by a predetermined height on the X-Y plane. When the photographing work is performed by using the camera in the real world, the camera is not located on the ground, but located on the vehicle or at the place having the height corresponding to the height of a person. Thus, if the 3-D object is located as mentioned above, the view point can be located closest to the camera performing the photographing work. Therefore, it is preferred to locate the center of the 3-D object at the position, which is spaced in the Z-axis direction by a height of the camera on the X-Y plane.

The inside of the 3-D object serves as the background of the avatars displayed in the image, so the 3-D object preferably has a size sufficient for covering a region slightly larger than a region where the avatars displayed in the image are located.

In addition, the 3-D image providing module 230 positions the 3-D avatars on the X-Y plane based on the coordinate information of the 3-D avatars. As described above, if the 3-D avatars are positioned on the X-Y plane, which corresponds to the real ground, the image can be provided to the user as if the avatar exists on the ground.

The avatars positioned in the 3-D space by the 3-D image providing module 230 may be located in the predetermined region having the center on the coordinate of the camera position. In order to facilitate the communication among the users, it is preferred to allow the avatars to meet each other in the space as many as possible. However, as described above, the inside image of the 3-D object must serve as the background of the 3-D avatars, so the avatars located out of the 3-D object are not displayed on the screen. In this regard, according to the present invention, a predetermined region is set about the camera position and only the avatars having the coordinate on the predetermined region are displayed.

In addition, the 3-D image providing module 230 displays the 3-D avatars after displaying the 3-D object on the screen in such a manner that the 3-D avatars can always be displayed in front of the 3-D object. In addition, the avatars can be adjusted according to the coordinate of the camera position and the distance between coordinates of the avatars to give the perspective to the avatars.

The 3-D image providing module 230 provides the user with the 3-D image having the viewpoint at the center of the 3-D object in the 3-D space through the display screen. As described above, the center of the 3-D object corresponds to the position of the camera photographing the background image. Thus, the user can handle the avatar of the user under the background as if the user looks around the environment from the camera position.

In order to allow the 3-D image providing module 230 to provide the 3-D image through the 2-D display screen by rendering the virtual 3-D space, the terminal equipped with the system 101 may have the 3-D acceleration function.

In addition, if the avatar of the user is moved or the view point of the user is changed, or if the information about the position change of the avatars of other users is received in the 3-D image providing module 230, the 3-D image providing module 230 may reconstruct the 3-D space to provide the user with the image as if the avatars are moved and the screen is rotated in the space.

The command receiving unit 240 receives the avatar moving command or the screen rotating command from the user. In the system 101 according to the present invention, the position and action of the avatar can be adjusted according to the commands of the user. Thus, the command receiving unit 240 receives the avatar moving command from the user. To this end, the terminal equipped with the system 101 may include a user interface, such as a mouse, a keyboard, or a touch screen. The screen rotating command is used to provide the 3-D avatar service in various view points and the command receiving unit 240 receives the screen rotating command through the user interface.

In addition to the above commands, the command receiving unit 240 may receive the command for changing the action of the avatar or the zoom-in/zoom-out command. However, the present invention is not limited by the functions additionally provided.

The controller 250 moves the avatar of the user on the X-Y plane according to the avatar moving command and rotates the screen provided at the above viewpoint according to the screen rotating command. The system 101 according to the present invention can move the avatar and rotate the screen according to the commands of the user, and the controller 250 controls the 3-D image providing module 230 according to the commands of the user to provide the 3-D image to the display device.

In addition, the controller 250 checks whether the avatar of the user deviates from a first region having the center at the camera position on the X-Y plane, and controls the 3-D image providing module 230 to provide the 3-D image using the 2-D image data corresponding to the camera position closest to the avatar of the user, if the avatar of the user deviates from the first region. In this manner, the position of the avatar can be moved, so that the system 101 can always provide the 3-D image by using the background image obtained from the camera position closest to the avatar of the user.

The region checked by the controller 250 has a square shape having the center on the camera position and is configured as a paduk board. The image can be provided by the camera located at the center of the region whenever the region is changed. In addition, the region can be established to include the adjacent camera position in such a manner that the movement of the camera position can be realized only when the region including the adjacent camera position is changed. In this manner, when the avatar of the user is moved in one direction, the camera can provide the image in the same direction.

For instance, when the avatar of the user is moved in one direction, if the image obtained from the adjacent camera position is provided even though the avatar does not pass through the adjacent camera position, the image having the direction opposite to the direction of the view point of the previous camera must be provided to display the avatar on the screen. However, if the image obtained from the adjacent camera position is provided after the avatar passes through the adjacent camera position, the image having the direction identical to the direction of the image obtained from the previous camera position can be provided, so the image may be more natural.

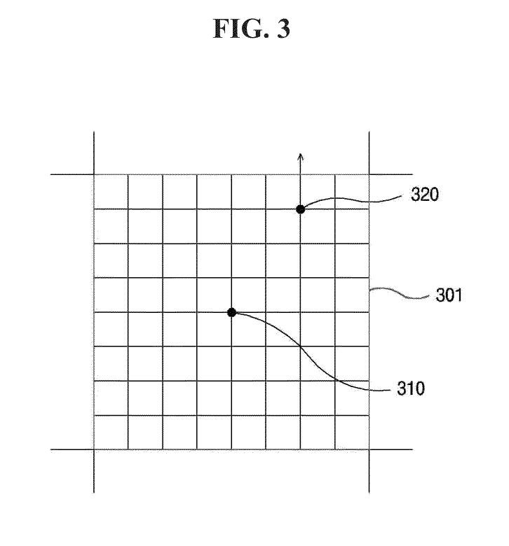

FIG. 3 is a view showing an example of a camera region formed on the X-Y plane in the system 101 for providing a 3-D avatar service according to one embodiment of the present invention.

As shown in FIG. 3, a specific region having the center on one camera position 301 is set as a camera region 301. If the avatar 320 of the user exists in the camera region 301, the 3-D image obtained from the camera position 301 is provided to the user. If the avatar 320 moves to another region, the 3-D image is provided by using the camera located at the center of another region.

In this manner, the camera regions are set by using a plurality of camera positions and the avatar is freely moved through the camera regions. If the avatar moves to another region, the 3-D image is provided by using the camera position located at the center of another region. Thus, the image can be provided to the user as if the avatar freely moves in the real space.

As described above, the camera regions are set to exclude the adjacent camera position. Thus, one camera region may overlap with the adjacent camera region. In addition, the camera regions can be set in the form of a paduk board to surround each camera position such that the camera regions may not overlap with each other.

In addition, the size of the camera region can be determined according to the distance between adjacent camera positions. The distance between adjacent camera positions corresponds to the distance between adjacent cameras obtained in the real world. If the distance between the adjacent camera positions is short, the background image suitable for the position of the avatar can be provided, so that the accurate depiction is possible, but the background image may be frequently changed so that image may be unstable. If the distance between the adjacent camera positions is long, the accurate depiction is impossible, but the image can be stably provided. Thus, the photographing work must be performed while properly maintaining the distance between the adjacent camera positions.

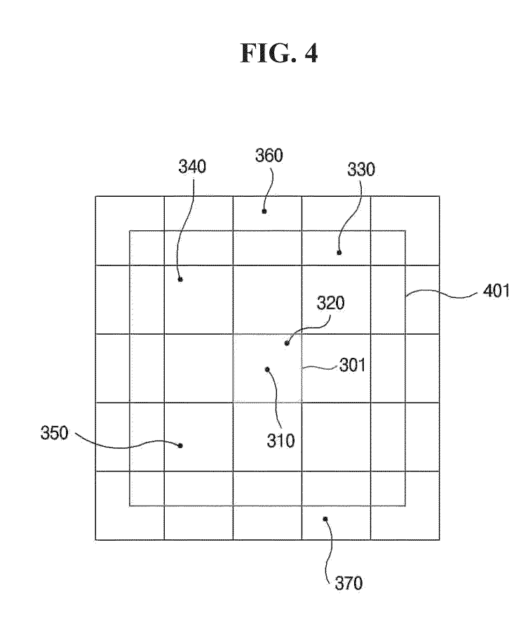

FIG. 4 is a view showing an example of an avatar display region formed on the X-Y plane in the system 101 for providing the 3-D avatar service according to one embodiment of the present invention.

As described above, in the system 101 for providing the 3-D avatar service according to the present invention, the avatars of other members can be displayed as well as the avatar of the user to facilitate the communication among the users by using the avatars. Since the avatars of all users accessing the system 101 may not be displayed on the screen, only the avatars located in a predetermined range are displayed.

Referring to FIG. 4, the avatar 320 of the user is displayed about the camera position 310. As described above with reference to FIG. 3, if the avatar 320 of the user exists in the camera region 301, the image is provided about the camera position 310. In addition, an avatar display region 401 having the center on the camera position 310 can be set to display the avatars located in the avatar display region 401.

The avatars indicated by reference numerals 330, 340 and 350 are displayed in the image, and avatars indicated by reference numerals 360 and 370 are not displayed in the image. If the avatar 320 of the user moves to another camera region, a new avatar display region is set about the camera position located on the center of another camera region to display the avatars existing in another camera region. Although the avatar display region 401 is configured as a rectangular shape in FIG. 4, the avatar display region 401 may have a circular shape or other shapes.

In this manner, the avatar 320 of the user can communicate with the avatars 330, 340 and 350 of other users on the screen. The avatars, which are positioned out of the avatar display region 401, are located far from the background displayed on the screen. These avatars can be displayed on the screen only when the avatar 320 of the user moves toward these avatars.

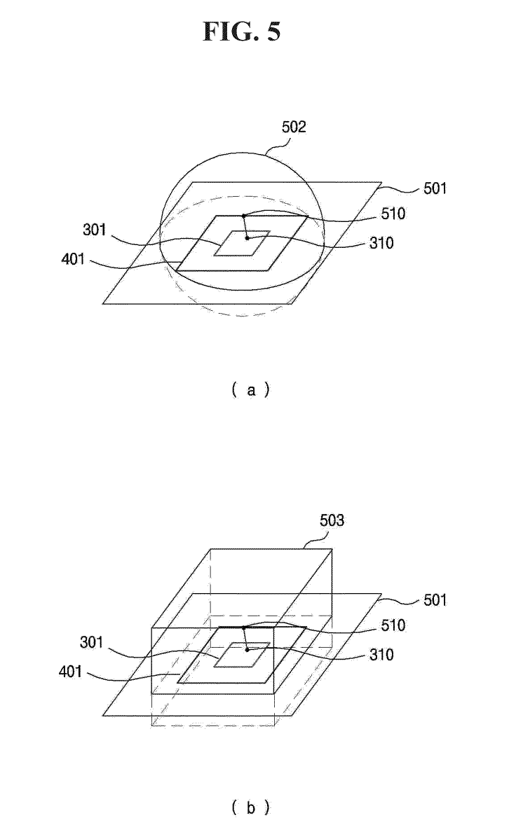

FIG. 5 is a view showing an example of positioning the 3-D object on the X-Y plane in the system for providing the 3-D avatar service according to one embodiment of the present invention.

As shown in FIG. 5, 3-D objects 502 and 503 are positioned such that the 3-D objects 502 and 503 have the center 510 on the coordinate of the camera position 310 on the X-Y plane 501. At this time, the center 510 of the 3-D objects 502 and 503 is spaced from the camera position 310 in the Z-axis direction by the height of the camera position. Since the center 510 of the 3-D objects 502 and 503 is located at the position spaced from the camera position 310 by the height of the camera position, the image can be provided under the background as if the user looks around the environment from the camera position.

The 3-D object may have the spherical shape as shown in FIG. 5(a) or a regular hexahedral shape as shown in FIG. 5(b). The 3-D object may have various shapes, so it is necessary to photograph and edit the image to provide the image corresponding to the image in the real world.

As shown in FIG. 5, preferably, the avatar display region 401 is limited within the range of the 3-D objects 502 and 503 because the background image is mapped in the 3-D objects 502 and 503 and the view point exists in the 3-D objects 502 and 503. If the avatar display region 401 has an area beyond the 3-D objects 502 and 503, the avatars located far from the background may be displayed in front of the background, so that the image may be distorted. To prevent the distortion of the image, the avatar display region 401 is preferably limited within the range of the 3-D objects 502 and 503.

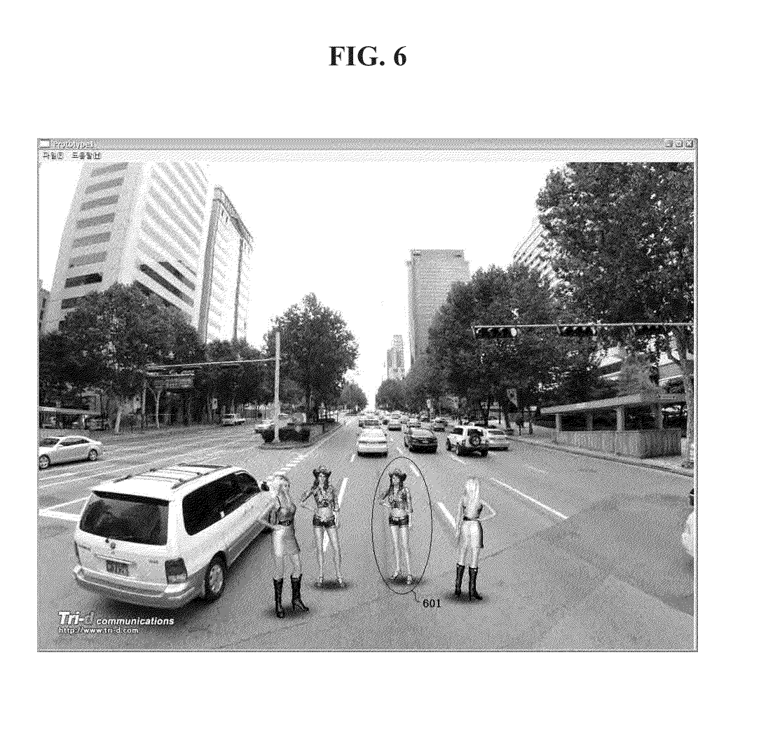

FIGS. 6 to 9 are views showing examples of 3-D images provided in the system 101 for providing the 3-D avatar service according to the present invention.

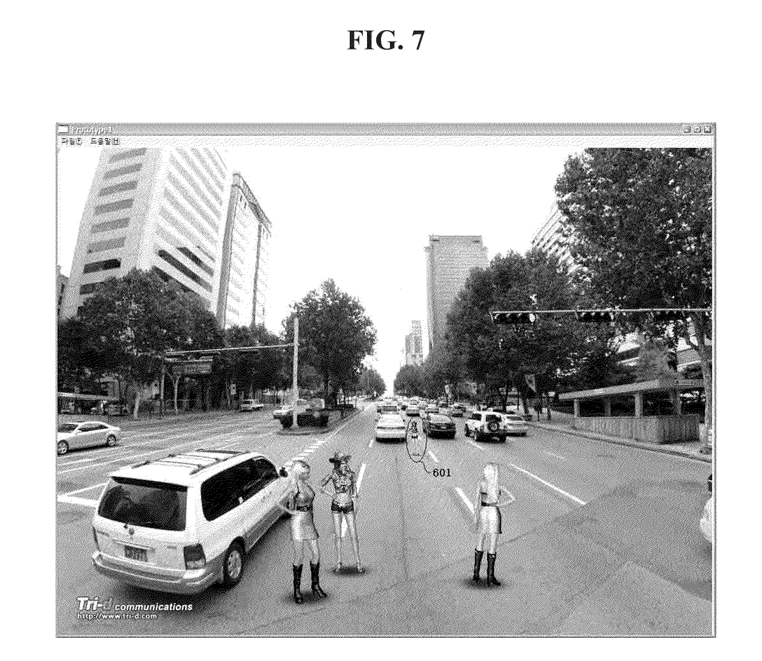

FIG. 6 is a view showing an avatar 601 of the user and avatars of other members provided from the system 101 according to the present invention as if the avatars exist on the real road. In addition, FIG. 7 is a view showing the avatar 601 of the user, which has been moved far from the initial position.

As shown in FIG. 7, the avatar can freely move in the 3-D virtual space according to the commands of the user. In addition, the real world is provided as the background, so that the image can be provided as if the avatar 601 of the user moves in the real world. Further, in order to provide the image having the reality, if the avatar 601 of the user is located far from the camera position as shown in FIG. 7, the size of the avatar 601 is reduced to give the perspective to the avatar 601.

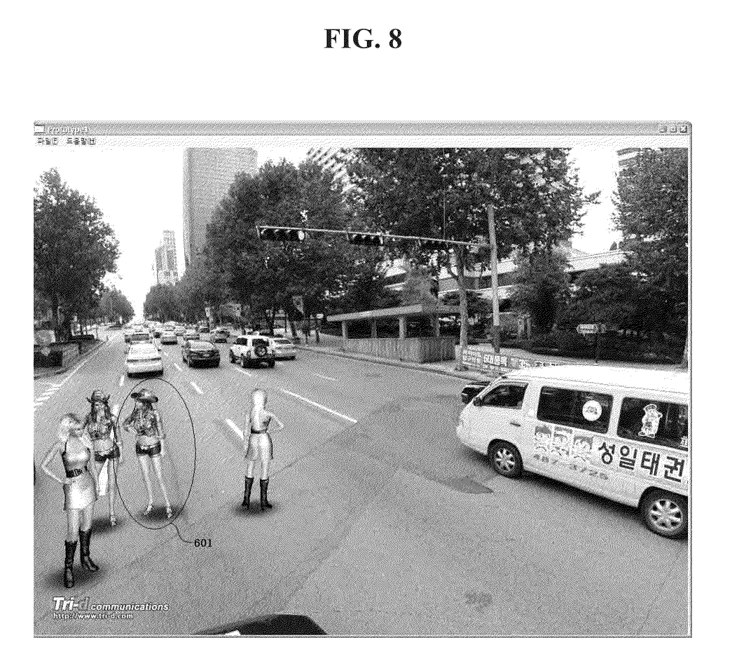

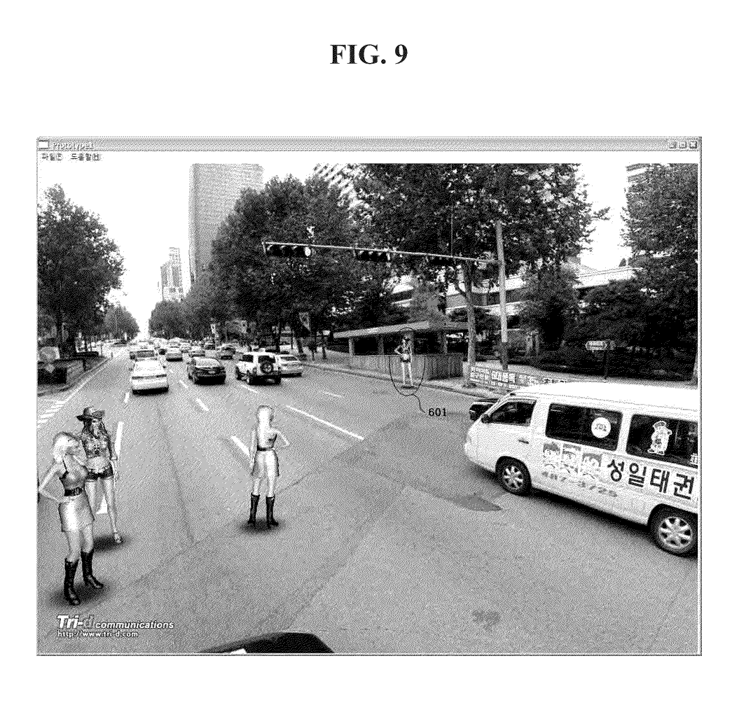

FIGS. 8 and 9 are views showing the image provided from the camera position similar to that of FIGS. 6 and 7. In FIGS. 8 and 9, the direction of the image is changed according to the commands of the user. The user can look around the environment about the camera position and may move the avatar to a desired position. FIG. 9 is a view similar to FIG. 7, in which the avatar 601 of the user is moved far from the camera position.

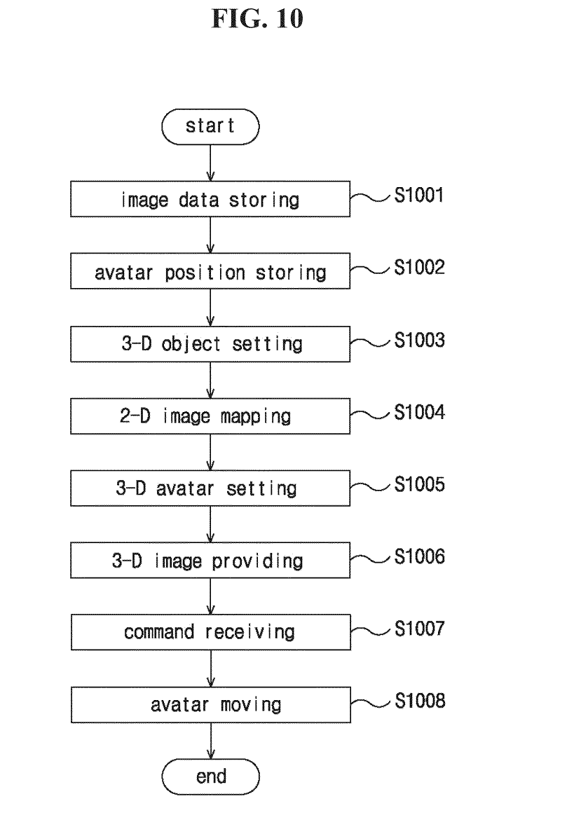

FIG. 10 is a flowchart showing a method for providing the 3-D avatar service according to one embodiment of the present invention. The method for providing the 3-D avatar service according to the present invention is not limited to FIG. 10, but can be variously modified. In addition, the structure of the system 101 is applied to the method for providing the 3-D avatar service.

In step S1001, the 2-D image data photographed from at least one camera position and the coordinate information of each camera position on the X-Y plane are stored in correspondence with the camera position. The 2-D image data and the coordinate information of the camera position may be provided from the system 101. In addition, the information corresponding to the present camera position maybe temporally stored. In the case that the 2-D image data and the coordinate information of the present camera position are stored, if the camera position is changed, it is possible to request the 2-D image data and the coordinate information corresponding to the new camera position to the server 102 to store the 2-D image data and the coordinate information corresponding to the new camera position.

When the real map is represented as a plane, the X-Y plane described in the present invention refers to the plane indicated in the map when the coordinate is applied to the map. In detail, the X-Y plane may represent the plane corresponding to the ground in the real world.

In step S1002, the coordinate information of at least one 3-D avatar on the X-Y plane is stored. The coordinate information on the X-Y plane can be expressed as (x and y) by storing the coordinate value in the X-axis and the coordinate value in the Y-axis in correspondence with each other.

In addition, in step S1002, the position information of the avatars of all members may be stored or the position information of the avatars of some members may be stored. Further, the position information of the avatars located in a predetermined range about the present camera position may be temporally stored in the storage device, such as the memory or the hard disc. If the position of the avatars or the camera position is changed, it is possible to receive the position information of the avatars from the server 102 to update the information of the avatars.

In step S1003, the 3-D object is positioned such that the 3-D object has the center on the coordinate of the camera position. The 3-D object may have the spherical shape or the regular hexahedral shape. The center of the 3-D object is located at the position, which is spaced in the Z-axis direction by the height of the camera position on the X-Y plane.

In step S1004, the 2-D image data corresponding to the camera position is mapped in the 3-D object. If the 2-D image data is mapped in the 3-D object, the image with the background having the reality can be provided when viewed from the center of the 3-D object. Since the center of the 3-D object is spaced in the Z-axis direction by the height of the camera position on the X-Y plane in step S1003, the user may feel as if the user looks around the environment from the position of the camera photographing the image.

In step S1005, the 3-D avatar is positioned on the X-Y plane based on the coordinate information of the 3-D avatars. As described above, the avatars are located within the predetermined range about the camera position. Since the avatar of the user and the avatars of other members are located in the 3-D space and the image of the avatars are provided to the user, the user can communicate with other members in on-line by using the avatar.

In step S1006, the 3-D image having a view point on the center of the 3-D object is provided. The 3-D image can be provided by rendering the 3-D space such that the 3-D space can be displayed on the 2-D display screen. Thus, since the center of the 3-D object becomes the view point, the user may feel as if the user looks around the environment from the camera position.

In step S1007, the avatar moving command or the screen rotating command is received from the user. According to the present invention, the avatar can be moved according to the commands of the user and the user may look around the background in the desired direction, so it is necessary to receive the avatar moving command or the screen rotating command from the user using the user interface, such as a keyboard, a mouse or a touch screen.

In step S1008, the avatar of the user is moved on the X-Y plane according to the avatar moving command and the angle of the screen, which is provided at the view point, is changed according to the screen rotating command. If the avatar of the user moves to the other camera region beyond the present camera position, a new 3-D image is provided to the user based on the adjacent camera position, so that the avatar of the user can freely move in the wide virtual space defined by a plurality of camera positions under the background photographed by the camera closest to the avatar of the user.

The method for providing the 3-D avatar service according to one embodiment of the present invention can be embodied as a program command executed by various computer devices and can be recorded in a computer readable recoding medium. The computer readable recoding medium may include a program command, data file, a data structure, and a combination thereof. The program command recorded in the computer readable recoding medium may be specially designed or configured for the present invention. In addition, the program command generally known in the art can be used for the present invention. For instance, the computer readable recoding medium may include magnetic media, such as a hard disc, a floppy disc and a magnetic tape, optical media, such as a CD-ROM or a DVD, magneto-optical media, such as a floptical disc, and a hardware apparatus, such as a ROM, a RAM or a flash memory capable of storing and executing the program command. The program command may include a machine code made by a compiler, and a high language code executable by the computer using an interpreter. The hardware apparatus may include at least one software module to perform the operation of the present invention.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A system for providing a 3-D avatar service, the system comprising:
an image data storage unit for storing 2-D image data photographed from at least one camera position, and coordinate information of each camera position on an X-Y plane in correspondence with the camera position;
an avatar position storage unit for storing coordinate information of at least one 3-D avatar on the X-Y plane;
a 3-D image providing module positioning a 3-D object such that the 3-D object has a center on a coordinate of the camera position, mapping the 2-D image data corresponding to the camera position in the 3-D object, positioning the 3-D avatar on the X-Y plane based on the coordinate information of the 3-D avatar, and providing a 3-D image having a view point on the center of the 3-D object;
a command receiving unit for receiving an avatar moving command or a screen rotating command from a user; and
a controller for moving an avatar of the user on the X-Y plane according to the avatar moving command and rotating an angle of a screen, which is provided at the view point, according to the screen rotating command.

2. The system of claim 1, wherein the controller checks whether the avatar of the user deviates from a first region having a center on the coordinate of the camera position on the X-Y plane, and controls the 3-D image providing module to provide the 3-D image using the 2-D image data corresponding to the camera position closest to the avatar of the user, if the avatar of the user deviates from the first region.

3. The system of claim 1, wherein the 3-D image providing module displays avatars positioned in a second region having a center on the coordinate of the camera position on the X-Y plane.

4. The system of claim 1, wherein the center of the 3-D object is located at a position, which is spaced in a Z-axis direction by a height of the camera position on the X-Y plane.

5. The system of claim 1, wherein the 3-D image providing module displays the 3-D avatars after displaying the 3-D object mapped with the 2-D image data.

6. The system of claim 1, wherein the 3-D image providing module adjusts a size of the 3-D avatars according to a distance between the coordinate of the camera position and the coordinate of the 3-D avatars.

7. The system of claim 1, wherein the 3-D object has a spherical shape.

8. A method for providing a 3-D avatar service, the method comprising:
storing 2-D image data photographed from at least one camera position, and coordinate information of each camera position on an X-Y plane in correspondence with the camera position;
storing coordinate information of at least one 3-D avatar on the X-Y plane;
positioning a 3-D object such that the 3-D object has a center on a coordinate of the camera position;
mapping the 2-D image data corresponding to the camera position in the 3-D object;
positioning the 3-D avatar on the X-Y plane based on the coordinate information of the 3-D avatar;
providing a 3-D image having a view point on the center of the 3-D object;
receiving an avatar moving command or a screen rotating command from a user; and
moving an avatar of the user on the X-Y plane according to the avatar moving command and rotating an angle of a screen, which is provided at the view point, according to the screen rotating command.

9. The method of claim 8, further comprising:
checking whether the avatar of the user deviates from a first region having a center on the coordinate of the camera position on the X-Y plane; and
providing the 3-D image using the 2-D image data corresponding to the camera position closest to the avatar of the user if the avatar of the user deviates from the first region.

10. The method of claim 8, wherein the providing of the 3-D image includes displaying avatars positioned in a second region having a center on the coordinate of the camera position on the X-Y plane.

11. The method of claim 8, wherein the center of the 3-D object is located at a position, which is spaced in a Z-axis direction by a height of the camera position on the X-Y plane.

12. The method of claim 8, wherein the positioning of the 3-D avatar includes adjusting a size of the 3-D avatars according to a distance between the coordinate of the camera position and the coordinate of the 3-D avatars.

13. The method of claim 8, wherein the 3-D object has a spherical shape.

14. A computer readable recording medium recorded with a program for executing the method of claim 8.
